(19) United States
(12) Patent Application Publication
(10) Pub. No.: US 2017/0192625 A1
(43) Pub. Date: Jul. 6, 2017

(54) DATA MANAGING AND PROVIDING METHOD AND SYSTEM FOR THE SAME

(71) Applicants: Young Kim, Danville, CA (US); Jee Hyun Kim, Washington, DC (US); Hyo Won Kim, Washington, DC (US)

(72) Inventors: Young Kim, Danville, CA (US); IImi Yoon, San Ramon, CA (US)

(21) Appl. No.: 14/985,695

(22) Filed: Dec. 31, 2015

(51) Int. Cl. G06F 3/0482; G06F 17/30; G06F 3/0481; G06Q 10/10; H04W 4/02; G06F 3/0484

(52) U.S. Cl. CPC G06F 3/0482; H04W 4/02; G06F 3/04842; G06F 3/04817; G06Q 10/1093; G06F 17/3028; G06F 17/30265

(57) ABSTRACT

A data managing and providing method which is performed by a data managing and providing system in a computing device may be provided that includes: generating a picture cluster including a plurality of pictures in accordance with a first condition among pictures newly accessible to the computing device after a predetermined period of time; obtaining a first data associated with the picture cluster from the computing device; and storing the picture cluster and the first data as one event.

### BACKGROUND

Field

The present invention relates to a data managing and providing method in a computing device and a system for the same, and more particularly to an integrated data managing and providing method which organically links and/or classifies data to be stored in a computing device or to be accessed through the computing device, and then converts the data into information meaningful to a user and stores and/or provides the information, and a system for the same.

Description of Related Art

Recently, a portable terminal such as a smartphone, a tablet personal computer, a personal data assistant, etc., is widely spreading. Modern people live their daily lives carrying the portable terminal for almost 24 hours. Therefore, it can be said that a computing device including the portable terminal is indispensable to modern people.

A user of the computing device is able to manage his/her schedule through a schedule management program, etc., included in the device, to take pictures, to read e-books, to obtain his/her necessary information through web sites, and to communicate with friends or virtual friends through a chatting application.

For the purpose of providing convenience to the computing device users, research is being devoted to an intelligent computing device. For example, research is actively being conducted to launch a product related to a chat robot which is capable of lessening a user's burden of schedule management by audio-visually outputting schedule information. However, only a time-based simple notification of the built schedule information through the chat robot cannot meet the expectation of the user, and thus, the satisfaction of the user may be reduced.

In order to allow the computing device to be used as a personal secretary, friend, advisor, or entertainer as well as to provide simple knowledge, information and notification, there is a requirement for a technology for converting data to be stored in the computing device or to be accessed through the computing device into information meaningful to the user, and for adequately providing the information to the user.

### SUMMARY

An embodiment is a data managing and providing method which is performed by a data managing and providing system in a computing device. The method may include: generating a picture cluster including a plurality of pictures in accordance with a first condition among pictures newly accessible to the computing device after a predetermined time point; obtaining a first data associated with the picture cluster from the computing device; and storing the picture cluster and the first data as one event.

### BRIEF DESCRIPTION OF THE DRAWINGS

FIG. 1 is a block diagram showing a data managing and providing system according to an embodiment of the present invention;

FIG. 2 is a flowchart showing a picture data managing method according to the embodiment of the present invention;

FIG. 3 shows a screen display displaying a menu of the data managing system according to the embodiment of the present invention;

FIGS. 4a to 4c are views of a screen display showing the picture data management process shown in FIG. 2;

FIGS. 5a and 5b show a screen display for shopping event generation and shopping event check according to the embodiment of the present invention;

FIGS. 6a and 6b show a screen display providing an event by means of a calendar view and a map view according to the embodiment of the present invention; and

FIG. 6c shows a screen display providing data retrieved by a timeline view way in accordance with the embodiment of the present invention.

### DETAILED DESCRIPTION

Hereafter, an exemplary embodiment of the present invention will be described in detail with reference to the accompanying drawings. Here, the embodiment of the present invention can be variously transformed, and the scope of the present invention is not limited to the following embodiment. The shapes and sizes of the components in the drawings may be exaggerated for clarity of the description. It is noted that the same reference numerals are used to denote the same elements throughout the drawings. In the following description of the present invention, the detailed description of known functions and configurations incorporated herein is omitted when it may make the subject matter of the present invention unclear.

A data managing and providing method and a system for the same disclosed in the present specification can be implemented with hardware, software or a combination of the hardware and software. For example, the data managing and providing method and the system for the same according to the embodiment of the present invention may be implemented in a kernel, in a separate user process, in a library package bound to network applications, on an specially configured machine, or on a network interface card, Also, the data managing and providing method and the system for the same according to the embodiment of the present invention may be implemented by an application which is driven on an operating system.

A software hybrid of at least some of the embodiment of the data managing and providing method and the system for the same disclosed in the present specification may be implemented on a programmable machine which is selectively activated or reconstructed by a computer program stored in a memory. The computing devices capable of implementing the data managing and providing method and the system for the same according to the embodiment of the present invention may include a plurality of network interfaces which can be configured or designed to use different types of network communication protocols. According to the embodiment of the present invention, at least some of the various characteristics and/or functions of the embodiment of the data managing and providing method and the system for the same disclosed in the present specification may be implemented by a computer system of an end user, a computer, a network server or server system, a portable computing device (e.g., personal digital assistant (PDA), a mobile phone, a smartphone, a laptop computer, a tablet PC or a thing similar thereto), a consumer electronic device, a music player, or any other suitable electronic device, a router, a switch or a thing similar thereto, or any combination of them, for example, at least one general purpose network host machine. In at least some of the embodiment, at least some of the various characteristics and/or functions of the embodiment of the data managing and providing method and the system for the same disclosed in the present specification can be implemented by at least one virtual computing environment (e.g., a network computing cloud or a thing similar thereto).

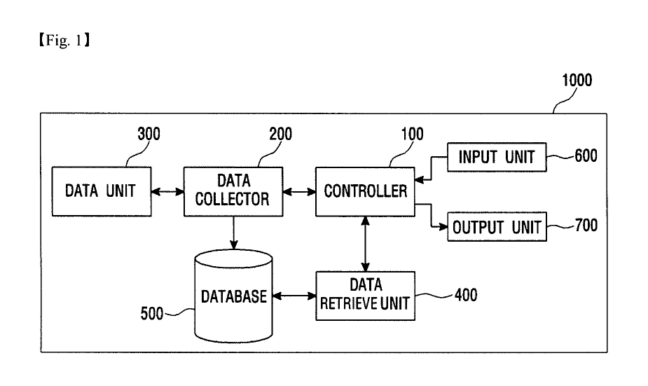

FIG. 1 is a block diagram showing a data managing and providing system 1000 according to an embodiment of the present invention.

At least some of the characteristics and/or functions of the data managing and providing system 1000 according to the embodiment of the present invention may be implemented by the computing device (not shown). This computing device may be, for example, a computer system of an end user, a network server or server system, a portable computing device (e.g., a PDA, a mobile phone, a smartphone, a laptop computer, a tablet PC or a thing similar thereto), a consumer electronic device, a music player, any other suitable electronic device, any combination of them, or parts thereof. This computing device may be configured to communicate with other computing devices such as a client and/or a server through a communication network like Internet by using a wired or wireless communication protocol.

According to the embodiment, the computing device may include a central processing unit (CPU). When the CPU operates under the appropriate control of software or firmware, the CPU can be responsible for implementing functions related to the functions of the computing device. For example, in the embodiment, the CPU of a PDA or a smartphone, etc., of a user may be configured or designed such that the PDA or smartphone can function as a data management system according to the embodiment. At least in one embodiment, the CPU of the computing device may be configured to perform a function and/or task of the system for managing and providing one or more different types of data under the control of software modules/components. The data managing and providing system according to the embodiment may be implemented by an application which is driven on the computing device. Hereafter, the following description will be provided by assuming that the data managing and providing system and method according to the embodiment are performed by a data managing and providing application which is driven on the computing device.

According to the embodiment, the CPU of the computing device may include one or more processors. As used in the present specification, the term “processor” is not limited to an integrated circuit which is referred to as a processor in the art, and may be widely referred to as a microcontroller, a microcomputer, a programmable logic controller, ASIC, and any other programmable circuit.

As shown in FIG. 1, the data managing and providing system 1000 according to the embodiment of the present invention may include a controller 100, a data collector 200, a database 500, a data retrieve unit 400, an input unit 600 and/or an output unit 700.

The data managing and providing system 1000 according to the embodiment of the present invention may perform functions of organically linking and/or classifying data which is stored in the computing device performing the data managing and providing method of the data managing and providing system 1000 or is accessed through the computing device, and then of converting the data into information meaningful to a user and storing and/or providing the information. Also, the data managing and providing system 1000 according to the embodiment of the present invention may perform functions of assisting the user in terms of education and amusement and of allowing the user to make better choices to improve the quality of life. Hereafter, the functions of the data managing and providing system 1000 according to the embodiment of the present invention will be described in detail together with its configuration.

The data collector 200 according the embodiment functions to collect data to be managed and provided through the data managing and providing system 1000. The data collector 200 may collect the data stored in a data unit 300. The data unit 300 may be included in the data managing and providing system 1000. However, the data unit 300 is not necessarily included in the data managing and providing system 1000. The data unit 300 may be included in a configuration which the data collector 200 can access. For example, the data unit 300 may be data stored in the computing device performing the data managing and providing system 1000. The data collector 200 may, for example, access a native application embedded in the computing device through an application interface and then may collect data. Also, the data collector 200 may access an application through an interface, which can be executed as a web-based application on the computing device, and then may collect data. Also, the data collector 200 may access an external database, a server system, and a cloud server, etc., which are capable of communicating with a corresponding computing device through a network, etc., through an interface, and then may collect data. Also, the data collector 200 may access an interactive device, etc., capable of communicating with the corresponding computing device through a network, through the interface, and then may collect data.

FIG. 1 shows that a configuration in which the data collector 200 collects the information is the data unit 300 within the data managing and providing system 1000. However, this is only for convenience of description. As described above, the data unit 300 in which the data collector 200 collects the information may be a native application, a web-based application, an external database, a server system, a cloud server, and/or an interactive device.

For instance, the data unit 300 may include a photo album, a calendar, a diary, a memo pad, contacts, a call record, a social network service (SNS) post, a short message service (SMS) message, etc.

The data collector 200 may collect a first data from the data unit 300. In the present specification, the first data may be referred to as data which can be directly accessed through the data collector 200. For example, the first data may be data which has been input in advance by the user of the computing device.

The data collector 200 may convert the first data collected from the data unit 300 into information meaningful to the user under the control of the controller 100. Here, if more data is required to convert the first data into the information meaningful to the user, the data collector 200 notifies the controller 100 of this fact.

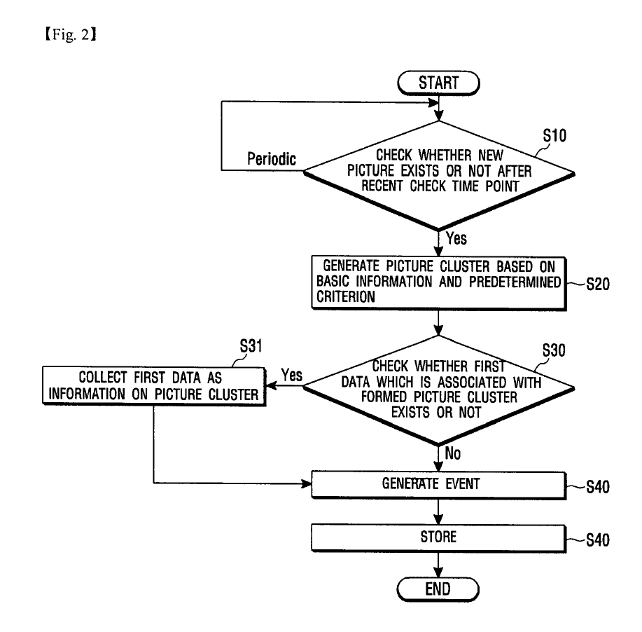

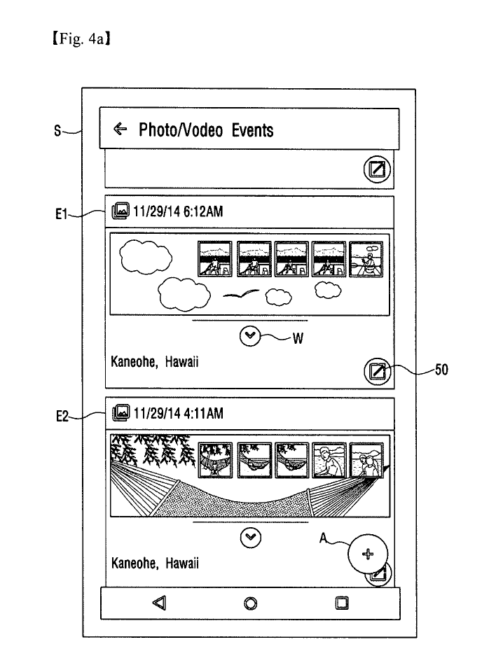

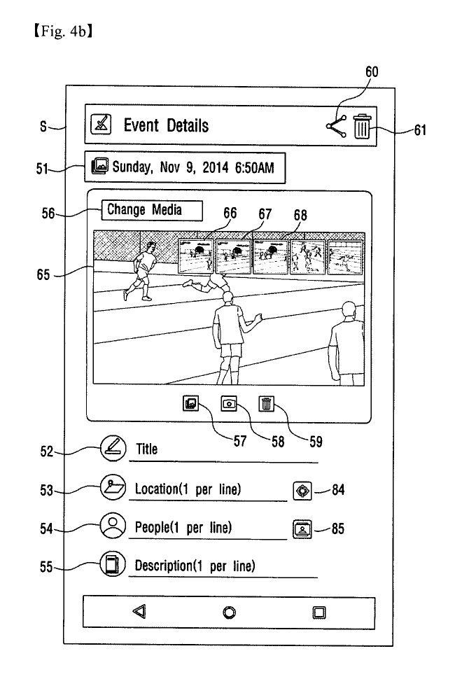

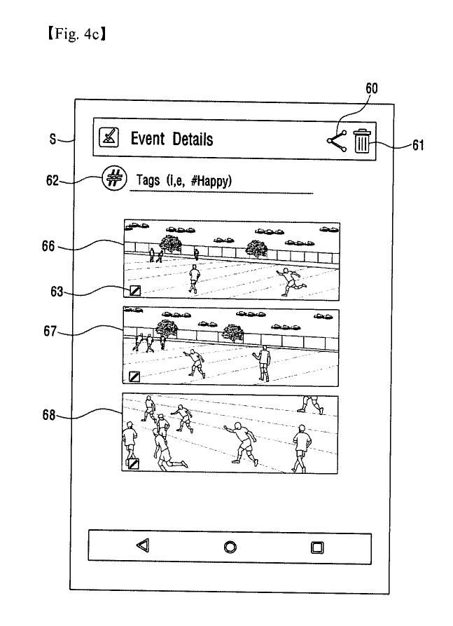

Here, in order to convert the first data into the information meaningful to the user, the user needs to input. The data collector 200 may provide a service such as photo clustering so as to minimize the input and effort of the user. This will be described in detail with reference to FIGS. 2 and 4.

An additional data required to collectively and/or organically link the first data which can be accessed by the data collector 200 and is dispersed in the computing device and to convert into the information meaningful to the user may be referred to a second data. The second data is required to convert the first data into the meaningful information on the basis of the first data. The second data may be a data needed to be input by the user.

For example, the data managing and providing system 1000 according to the embodiment may collect, store and/or provide the data in an event unit. As a result, the data collector 200 may collect and store the data by the event. The controller 100 may control the data collector 200 to collect the data of a predetermined item for each event. For example, the data collector 200 may collect the data by a predetermined item (what, who, how, why, when, where, picture, etc.) for each event. When the data of some (picture, when, where, etc.) of the predetermined items for a predetermined event is obtained as the first data, the data collector 200 may notify the controller 100 of the necessity of the additional data (what, who, how, emotion, etc.).

The data collector 200 may store the collected data in the database 500 in the event unit. Also, the meaningful information generated from the collected data may be stored in the database 500 in the event unit by the data collector 200. Here, the database 500 may include a memory included in the data managing and providing system 1000 and/or any storage included in the computing device. The database 500 may be an external database, a server system and/or a cloud server, which are located outside the computing device.

The data retrieve unit 400 according to the embodiment functions to provide information requested by the user to the user by retrieving the data that the data collector 200 has collected based on user's requests, etc., and the database 500 storing the information and/or event. The data retrieve unit 400 may provide the user with the search result according to a predetermined classification. For example, based on an event and in accordance with a time sequence, the data retrieve unit 400 according to the embodiment may provide the user with the data and information collected by the data collector 200. Here, the data retrieve unit 400 may provide the user with the information in a predetermined unit such as hour, day, week, month, or year, etc. This may be hereafter referred to as a timeline view way. Also, the data retrieve unit 400 may provide the retrieved data to the user through a map view or calendar view in the event unit. In the embodiment of the present invention, the data is provided to the user in various ways as described above, thereby allowing the user to select and use the data providing method in accordance with the information that the user has and the information that the user needs. Therefore, an information search efficiency can be improved.

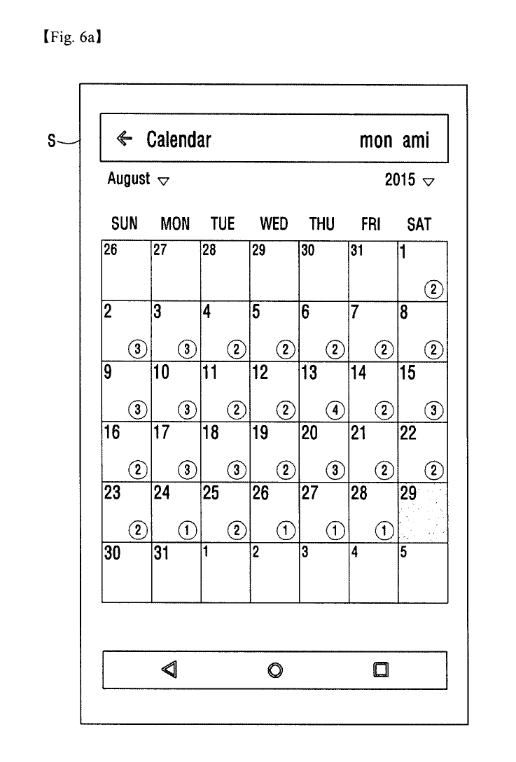

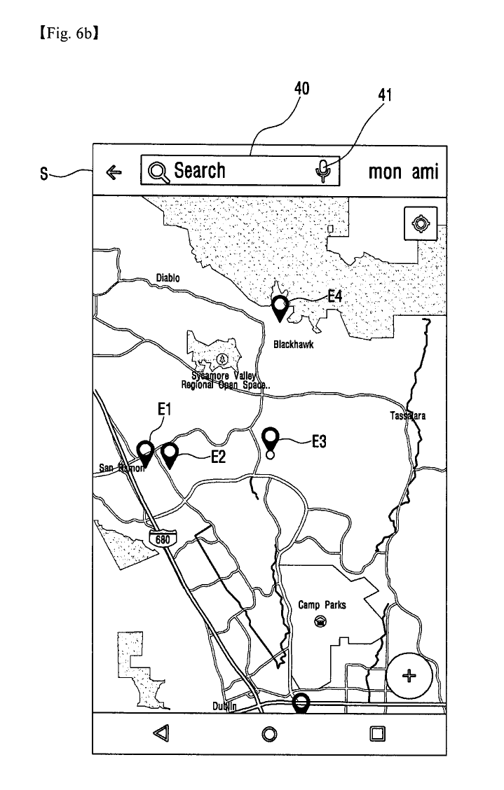

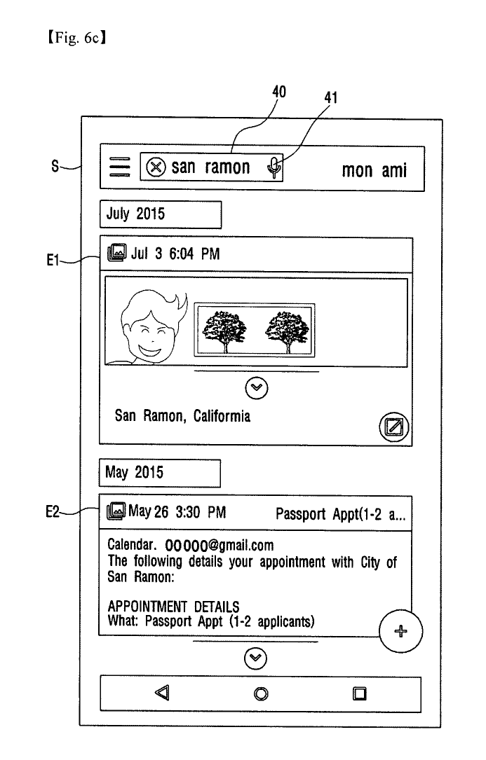

The information may be displayed on a screen which is a component of the computing device or an external component of the computing device. This will be described in detail with reference to FIGS. 6a to 6c.

The input unit 600 and the output unit 700 according to the embodiment may be means for receiving the input from the user and for outputting to the user. The input unit 600 and the output unit 700 may be components included in the data managing and providing system 1000 according to the embodiment, or may be components included in the computing device which includes the data managing and providing system 1000 according to the embodiment or performs the data managing and providing system 1000 according to the embodiment. The input unit 600 may include, for example, a keyboard, a touch screen, a microphone (for example, for voice input), a mouse, a touch pad, a trackball, a switch, a joystick and/or any combination of them, and may have any type suitable for receiving the user input. The output unit 700 may include a screen, a speaker, a printer, and/or any combination of them.

FIG. 2 is a flowchart showing a picture data managing method according to the embodiment of the present invention. The picture data managing method which is an example of the data managing method of the data managing and providing system 1000 according to the embodiment will be described with reference to FIG. 2.

Referring to FIG. 2, the picture data managing method according to the embodiment checks whether a new picture exists or not (S10). Here, the picture may be designated to include a video image as well as a picture. For example, the controller 100 controls the data collector 200 to check whether or not a picture is newly added to a photo album after a previous check time point. Here, a new picture may be checked periodically or at a specific point of time set by the user. Here, the check on the new picture may be freely performed every six hours, every twelve hours, every day, or every three days, etc. For example, the check on the new picture may be set to be performed every twelve hours by default. Here, the period of the check may be set according to a lifestyle of the user of the computing device.

When a new picture exists in a photo album of the data unit 300 after a recent check time point, the data collector 200 may generate a picture cluster based on basic information and a predetermined criterion (S20). The data collector 200 checks the location information and/or time information of the photographed picture on the basis of a meta-data of the new picture. Two or more pictures determined to maintain a temporal continuity are classified into one cluster, and then the picture cluster may be generated. Here, the temporal continuity may correspond to a case where an interval between the pictures adjacent in terms of time is less than a predetermined period of time. When the interval between two pictures adjacent in terms of time is greater than a predetermined period of time, it can be said that there is a temporal discontinuity between the two pictures, and the two pictures cannot be classified into one cluster. The predetermined period of time used to determine whether the pictures are classified into the cluster or not may be set by default or by the user. For example, the predetermined period of time may be set to two hours. The predetermined period of time may be determined and set by considering an activity pattern, etc., of the user.

For example, it is assumed that there are sequentially photographed pictures 1, 2, 3, 4, and 5. When a time interval between the picture 1 and the picture 2 is less than a predetermined period of time, a time interval between the picture 2 and the picture 3 is less than the predetermined period of time, a time interval between the picture 3 and the picture 4 is greater than the predetermined period of time, and a time interval between the picture 4 and the picture 5 is less than the predetermined period of time, the pictures 1, 2, and 3 may form a first cluster, and the pictures 4 and 5 may form a second cluster.

Here, according to the embodiment, in order that the plurality of pictures are classified into one cluster and form a picture cluster, a positional continuity may be required. For instance, the picture with the positional discontinuity among the plurality of pictures with the temporal continuity may be excluded from the picture cluster. For example, in the above-mentioned example, if the pictures 1 and 2 out of the pictures 1, 2, and 3 have been photographed at the same place and the picture 1 has been photographed at a place different from the above place, the picture 1 may not be included in the first cluster.

Here, the positional continuity may be determined according to a physical distance of a position where the picture has been photographed or according to a place where the picture has been photographed. In the latter case, the positional continuity may be determined according to a place (e.g., restaurant, shopping mall, park, . . . ) which can be obtained on the basis of a global positioning system (GPS) value of the position where the picture has been photographed or according to an area distinguished by an administrative district. For example, the positional continuity which is used to determine whether the pictures are classified into the cluster or not may be a condition that the picture is taken within a predetermined distance. The predetermined distance may be set by default or by the user. For instance, the predetermined distance may be set to 5 miles. The predetermined distance may be determined and set by considering an activity pattern, etc., of the user.

When the data collector 200 finds a new picture after a recent check time point and determines that the corresponding picture belongs to a picture cluster which has been already formed at the recent check time point, the corresponding picture can be added to a previously formed picture cluster.

The data collector 200 searches the data unit 300 and checks whether the first data which is associated with the formed picture cluster exists or not (S30). For example, the data collector 200 checks whether the first data associated with a time when and/or a place where a picture included in the picture cluster has been photographed exists or not in a calendar, a diary, a text message, an SNS post, a memo pad, etc. A plan named “family and amusement park” which includes a schedule including a time when a picture included in the picture cluster has been photographed may be recorded in a calendar. Here, the data collector 200 may temporarily store the corresponding picture cluster and the data “family and amusement” in association with each other. Likewise, data “with family in Disney Land” may be checked in a message transmitted to and received from friends during the time period when the picture has been photographed. The data collector 200 may temporarily store the corresponding picture cluster and the place data “Disney Land” in association with each other. The data collector 200 extracts the first data which is associated with the picture cluster formed in this way, and associates the picture cluster with the first data (S31), and then may generate and store an event (S40 and S50).

Even when the data collector 200 does not find the first additional data associated with the picture cluster, the data collector 200 generates and stores an event by using the picture cluster including the basic information (S40 and S50). Here, this basic information may be classified into the first data.

The fact that the data collector 200 has generated an event and stored in the database 500 may be notified to the controller 100. Here, a fact that a new event has been generated may be notified to the user. The user may check the new event, may write additional information if necessary, may remove the event, or may edit the event, for example, modification of the contents of the event.

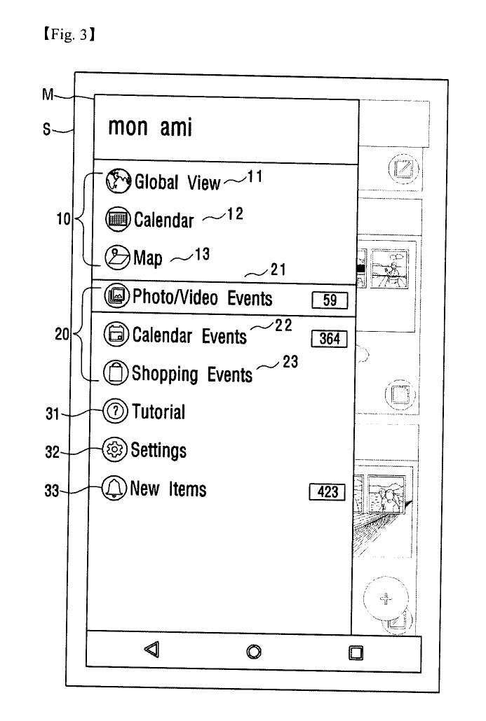

The controller 100 may be configured to notify the user of the existence of the new event. The process of notifying the new event, checking the event contents through the notification, writing information, and editing events will be described in detail with reference to FIGS. 3 and 4a to 4c.

The data management of the data managing and providing system 1000 according to the embodiment may be performed as a background service in the computing device. When there is a new event, the controller 100 may notify the user of the new event. The notification may be performed in any manner. For example, the fact that a new event has been generated may be transmitted to the user by a message, alarm, vibration, etc. When the user receives the notification and intends to check the event, the user may open a window for executing a data managing and providing application in the computing device. For example, by selecting an icon corresponding to the data managing and providing application displayed on the screen of the computing device, the window for executing the data managing and providing application may be displayed on the screen.

FIG. 3 shows a screen display displaying a menu of the data managing and providing system according to the embodiment of the present invention. For example, when the icon corresponding to the data managing and providing application is selected, a home page of the data managing and providing application may be displayed on a screen “S”. FIG. 3 shows that a menu window “M” of a service, which may be provided through the data managing and providing application according to the embodiment, is displayed.

The menu window of the application performing the data managing and providing method according to the embodiment may include icons in accordance with functions that the data managing and providing system 1000 according to the embodiment performs. For example, the reference numeral 10 represents a set of icons 11, 12, and 13 according to a method of providing the event to the user. For example, the icon 11 provides the event by the timeline view way. The icon 12 provides the event by a calendar view way. The icon 13 provides the event by a map view way. This will be described in detail with reference to FIGS. 6a to 6c.

The reference numeral 20 represents a set of icons 21, 22, and 23 representing event groups classified by attributes. For example, the icon 21 represents an event group including photo/video. The icon 22 represents an event group related to a schedule extracted from a schedule entry. The icon 23 represents an event group related to shopping. These event groups may be further subdivided and classified and may additionally include event groups with other attributes. For example, an event group related to hobbies, an event group related to works, an event group related to travels, etc., may be included. The classification of the event group may be set by default and may be possible to be changed/added/deleted by the user in accordance with the embodiment.

The reference numeral 31 may represent a tutorial icon capable of providing information including an instruction for the application performing the data managing and providing method according to the embodiment. The user is able to obtain information on how to use a corresponding application, etc., by selecting a corresponding icon 31.

The reference numeral 32 represents an icon for adding/changing/deleting basic setting items for performing the data managing and providing method according to the embodiment. Through the selection of a corresponding icon 32, the user is able to check/change/delete the setting items, for example, the maximum and/or minimum number of pictures for photo clustering, data that the data collector 200 can access so as to generate an event, a period of default time detected during the search of event, the maximum and/or minimum number of events which are displayed in a map view, a cycle to check whether a new event exists or not, and/or a predetermined time and a predetermined distance, etc., used to determine the temporal/positional continuity for photo clustering.

The reference numeral 33 may represent an icon showing the number of new items that the user has not yet checked as a new event in the application performing the data managing and providing method according to the embodiment of the present invention. “423” indicated on the right side of the icon 33 of FIG. 3 may represent the total number of new events. This may be, for example, a sum of a number 59 indicated on the right side of the icon 21 representing the photo/video event group and a number 364 indicated on the right side of the icon 22 representing the calendar event group. The number 59 indicated on the right side of the icon 21 means that 59 new events corresponding to the icon 21 are generated. The number 364 indicated on the right side of the icon 22 means that 364 new events corresponding to the icon 22 are generated.

FIGS. 4a to 4c are views of a screen display showing the picture data management process shown in FIG. 2. For example, when the icon 21 representing the photo/video event group in the menu shown in FIG. 3 is selected, a screen shown in FIG. 4a may be displayed on the screen “S”.

As shown in FIG. 4a, when the icon 21 is selected, an event “E” included in the corresponding group may be displayed. Here, a plurality of the events “E” included in the corresponding group may be provided and may be displayed on the screen “S” by a predetermined arrangement method. In FIG. 4a, a recent event may be displayed first in accordance with a time sequence, or only predetermined information may be displayed. In FIG. 4a, an event 1 “E1” and an event 2 “E2” are new events and may not be checked yet by the user.

The user is able to delete an event to be deleted among the displayed events without checking the specific details. For example, more information on the event 1 “E1” can be checked by selecting an icon W shown in FIG. 4a. Also, the user is able to select an event to be checked/edited among the displayed events. For example, the contents of the corresponding event 1 “E1” can be checked and edited by selecting an icon 50 shown in FIG. 4a.

FIG. 4b shows that the predetermined event “E” of FIG. 4a is selected. In this case, it is possible to check the details of the selected event. Through metadata of the pictures and/or video included in the photo/video event, the time information and/or location information may be included as event detailed information. For example, time information on the corresponding event may be displayed in a section indicated by a reference numeral 51. Location information on the corresponding event may be automatically written in a section indicated by a reference numeral 53 with reference to the metadata. The user is able to directly input information to be added while checking the contents of the corresponding event.

The user may add unwritten information in a screen displaying the details of the event shown in FIG. 4b. For example, the user may add/change/delete and store a title of the event in a section 52, event participants in a section 54, and/or other description of the event in a section 55. Here, the other description of the event may include the kind of the event. For instance, the user may write what kind the event belongs to among shopping, travel, meal, business, social activities, health, work, and hobby.

Also, the information collected by the data collector 200 may be filled in other sections (e.g., 52, 54, and 55) except the section 51 and/or the section 53. The user may check/edit the corresponding contents.

Also, when the location information is written in the section 53, an existing history information/directory may be used through an icon 84. Likewise, when person information is written in the section 54, contact information may be used through an icon 85.

The pictures included in the picture cluster of the corresponding event “E” may be displayed on the screen “S” in the form of a collage. According to the embodiment, a selected picture among the pictures included in the picture cluster or a representative picture 65 may be displayed relatively large and other pictures 66, 67, . . . may be displayed relatively small. The user may select an icon 56 and change/add/delete the picture registered in the corresponding event “E”. For example, a new picture can be added from the photo album by selecting an icon 57. A new picture can be photographed and added by selecting an icon 58. The selected picture can be deleted by selecting an icon 59.

For example, each of the pictures registered in the event “E” can be edited by selecting the icon 56 shown in FIG. 4b or by other methods. This is shown in FIG. 4c. As shown in FIG. 4c, the pictures corresponding to the event “E” may be displayed on the screen “S”. The description of the picture 66 can be added/changed/deleted by selecting an icon 63. This can be performed for each of the pictures 66, 67, 68, etc. Also, all the pictures 66, 67, 68, etc., can be selected and deleted at a time through an icon 61. Also, a tag may be written in a section 62 with respect to each of the pictures 66, 67, 68, etc., or the entire cluster.

When the editing of the picture included in the event “E” shown in FIG. 4c is completed or the editing of the information on the event “E” shown in FIG. 4b is completed, the editing information may be, for example, stored in association with the event “E” by pressing a storage button. The corresponding event “E” may be, for example, posted on the SNS through an icon 60 shown in FIG. 4b or 4c or may be shared with a third party through the SMS or messenger. Also, the corresponding event “E” itself can be deleted from an event list through an icon 61 shown in FIG. 4b.

A process of checking and editing the shopping event and calendar event may be also performed in the same manner as or a similar manner to that described with reference to FIGS. 4a to 4c.

Here, the data collector 200 collects a schedule entry that the user has input through the computing device, and thus, may generate the calendar event. For example, the data collector 200 accesses the schedule entry written in a schedule/calendar and then generates an event. For example, when the schedule describes “2 p.m. Sep. 30, 2015, Business meeting, Participant: OOO and OOO, Location: Seoul, Korea”, the data collector 200 may generate an event from the corresponding schedule and add to the calendar event. According to the embodiment, a picture may be added to the calendar event.

The user may generate directly events and add them as events appropriate for each category. For example, an “event generation” icon may be added to the menu window “M” shown in FIG. 3. The user may generate an event by selecting the corresponding icon, and then may add it to a desired category. Also, according to the embodiment, an event may be generated by selecting the event groups 21, 22, and 23 of each category among the menus shown in FIG. 3. For example, an icon “A” is selected in a screen shown in FIG. 4a, so that a new event generation window may be popped up. According to the embodiment, the user may generate a new event category.

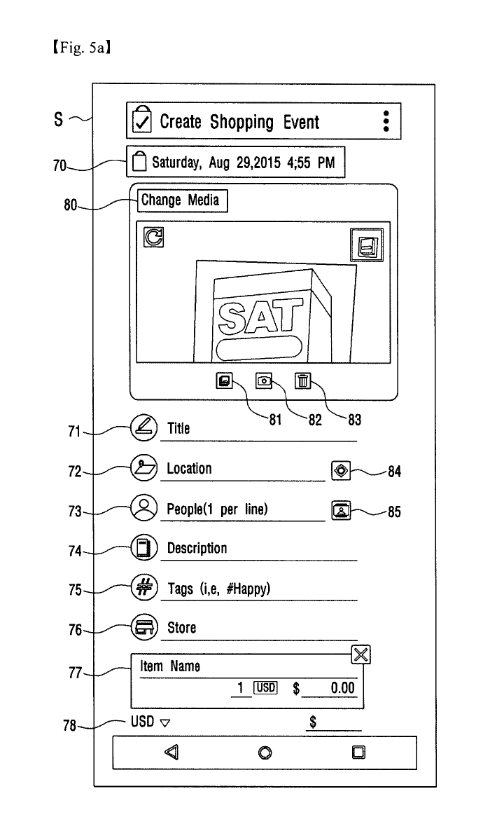

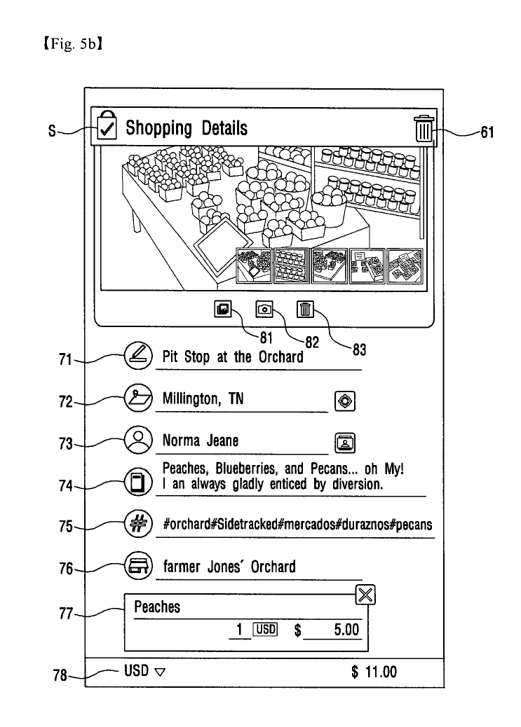

FIGS. 5a and 5b show a screen display for shopping event generation and shopping event check according to the embodiment of the present invention.

As shown in FIG. 5a, the user is able to generate a new shopping event through a screen display. As described with reference to FIGS. 4b and 4c, the user is able to edit pictures and to write the contents of each of sections 70, 71, 72, 73, and 74. The sections 70 and 71 corresponding to the time information and location information on the event generation may be automatically written, and the user is able to edit the corresponding contents.

As shown in FIG. 5a, a section 76 is added, and then information on a shop where shopping has been done may be additionally written. In case of the shopping event, as shown in FIG. 5a, a section 77 and a section 78 may be added. A corresponding item name and price information for each shopping item may be written in the section 77. This may be repeatedly performed for each shopping item. A total sum of the prices of the shopping items may be displayed in the section 78.

In FIG. 5a, a tag section 75 is added, and thus, tag information may be additionally written. It is clear that this tag information can be added to other event groups. The tag information which is written in the section 75 may make it easier to search later.

The event generated through the screen shown in FIG. 5a can be registered as a shopping event. The contents of the generated event can be, as shown in FIG. 5b, checked and edited by selecting the corresponding event later. This process may be performed in the same manner as those of FIGS. 4b and 4c.

Also, the category of the already generated event may be changed later and then registered. For example, an event registered as a photo/video event through the data collector 200 may be changed later into a shopping event by the user.

As described above, the information which is collected by the data collector 200 may be checked and the information which is additionally written by the user may be stored in the database 500 in association with the event. When the user searches the information later, the information can be provided to the user in the unit of the event stored in this way.

The data managing and providing system 1000 according to the embodiment may provide data collected on the screen “S” by displaying the data in the event unit. The method of providing the data to the user in the event unit may be variously performed. As the reference numeral 10 indicates in the menu window “M” of FIG. 3, the event may be provided by the timeline view way (11), by the calendar view way (12), or by the map view way (13).

FIGS. 6a and 6b show a screen display providing an event by means of the calendar view and the map view according to the embodiment of the present invention.

By selecting the icon 12 shown in FIG. 3, the events generated by the data managing and providing system 1000 according to the embodiment of the present invention are displayed on the calendar and are provided to the user. This is shown in FIG. 6a. As shown in FIG. 6a, the number of the events corresponding to each date of the calendar may be displayed. The user may select the calendar view so as to check/search the event corresponding to a specific date. For example, when the user intends to check the event corresponding to Aug. 20, 2015, the user can select the corresponding date. In this case, three events marked on Aug. 20, 2015 may be, for example, as shown in FIG. 4a, displayed on the screen “S”. The user is able to check the details of the event displayed on the screen “S”. As such, since the data is provided in the event unit through the calendar view, the user is able to easily check the event corresponding to a specific date.

By selecting the icon 13 shown in FIG. 3, the events generated by the data managing and providing system 1000 according to the embodiment of the present invention are displayed on the map and are provided to the user. This is shown in FIG. 6b. As shown in FIG. 6b, the event may be displayed on the map in accordance with the event generation position. The user starts searching by typing a predetermined position in a search window 40 or by inputting voice through a microphone 41. The map may be magnified including the corresponding position, and an event in an area including the corresponding position may be displayed on the map. The user may check the details of the event by selecting the event to be checked among the displayed events. As such, since the data is provided in the event unit through the map view, the user is able to easily check the event corresponding to a specific place/position. According to the embodiment, the search may be performed by inputting a predetermined search word to the search window 40/microphone 41. An event including the corresponding keyword may be displayed on the map. Therefore, the user is able to check his/her activity pattern, etc., through the map view.

FIG. 6c shows a screen display providing a searched event by the timeline view way. By selecting the icon 11 shown in FIG. 3, the events generated by the data managing and providing system 1000 according to the embodiment of the present invention are displayed on the screen by the timeline view way and are provided to the user. For example, the event during a predetermined time interval or all of the events which have been generated up to now may be displayed by the timeline view way.

FIG. 6c shows that a search word is input through the search window 40 or the microphone 41, and thus, only the search results are provided by the timeline view way among the events displayed by the timeline view way. The search word of FIG. 6c is “San Ramon”, and events including the corresponding keyword are displayed on the screen “S” in accordance with a time sequence. The search results, i.e., an event 1 “E1” of July 2015 and an event “E2” of May 2015 may be displayed on the screen “S” and provided. The event 1 “E1” is of the category of the photo/video event including pictures taken in the city of “San Ramon”, and the event “E2” is of the category of the calendar event based on the reservation in the city of “San Ramon”, which has been recorded in the schedule. The user is able to check the event including necessary information among the events displayed on the screen “S”. The user is able to select each event and check the details of the event, if necessary.

When the event is displayed by the timeline view way, all of the events may be displayed in a reverse chronological order based on the current time. Here, a start time of each event may be displayed.

When the event is displayed by the timeline view way, the corresponding event may include a picture. In this case, each of the events may be displayed together with the collage image of the picture, description of the event, participants, activity, category, and event place and/or event time. According to the embodiment, only some of the data may be displayed.

According to the embodiment, when the event is displayed by the timeline view way, it is possible to display the event in daily, weekly, monthly, and yearly views as well as all of the events. For example, when the event is displayed in a day unit, an event item may be displayed one by one in a day unit. Also, according to the embodiment, each event item may be displayed by summarizing all of the events of the corresponding date.

Similarly to this, when the event is displayed in a week unit, the event item may be displayed one by one in a week unit. Also, according to the embodiment, each event item may be displayed by summarizing all of the events of the corresponding week.

Similarly to this, the event may be displayed in a month unit or in a year unit. Also, in daily, weekly, monthly, and yearly views, it is possible to convert any one view into another view.

The data managing and providing system 1000 according to the embodiment may provide the user with necessary information in accordance with the user's request. Here, the data managing and providing system 1000 may respond to the user's request by displaying an event including the information on the user's request on the screen “S” by the timeline view way.

The user is able to request a service from the data managing and providing system 1000 by typing a request in the search window 40 shown in FIG. 6b or 6c. Also, the user is able to request a service by inputting a request by voice through the microphone 41. The controller 100 controls the data retrieve unit 400 to retrieve for the event including data related to the corresponding request among the events stored in the database 500, thereby providing all of the corresponding events to the user. Also, according to the settings, only the event during a predetermined time period may be provided to the user.

The data managing and providing system 1000 according to the embodiment is able to provide the user with all of the events including responses corresponding to the user's request instead of providing the user with only a direct response to the user's request. As a result, the user checks all of the events including responses to the user's request, thereby resolving the questions associated with the corresponding response. For example, when the user uses a city name “San Ramon” as a search formula, the user may wonder a date and time when he/she has visited “San Ramon” and why he/she went to the city. This can be solved by checking the information included in the event associated with “San Ramon”.

As described above, according to the data managing and providing system and method according to the embodiment, the user-related data is actively collected through the computing device by the data managing and providing system and method, and then the collected data are organically linked and converted into meaningful information. Here, the user is allowed to add additional information required during this process and to edit already stored data. As a result, the user is able to efficiently manage the data and to correct incorrect information, thereby improving the reliability of the information. Therefore, according to the embodiment, more data related to the user can be collected, converted into meaningful information, and stored without a requirement for user's active action. Also, based on this information, the user is able to more effectively use the information.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A data managing and providing method which is performed by a data managing and providing system in a computing device, the method comprising:
generating a picture cluster comprising a plurality of pictures in accordance with a first condition among pictures newly accessible to the computing device after a predetermined time point;
obtaining a first data associated with the picture cluster from the computing device; and
storing the picture cluster and the first data as one event.

2. The data managing and providing method of claim 1,
wherein the first data comprises a time data and a location data of the picture cluster,
and wherein the first data is stored in the computing device or is accessible through the computing device.

3. The data managing and providing method of claim 1, wherein the first condition is at least one of a temporal continuity and a positional continuity.

4. The data managing and providing method of claim 1, further comprising storing a schedule entry accessible to the computing device, at least together with time information, as another event.

5. The data managing and providing method of claim 1, further comprising generating and storing a new event by a user's input.

6. The data managing and providing method of claim 1, further comprising displaying the stored event on a screen of the computing device in accordance with a timeline.

7. The data managing and providing method of claim 6, further comprising displaying the stored event on a screen of the computing device in accordance with the timeline in such a manner as to be displayed in a predetermined time unit.

8. The data managing and providing method of claim 1, further comprising:
inputting a command by the user; and
retrieving an event comprising data according to the inputted command among the stored events, and then displaying the event on a screen of the computing device in accordance with a timeline.

9. The data managing and providing method of claim 1, further comprising:
inputting a command by the user; and
retrieving an event comprising data according to the input command among the stored events, and then displaying the event on a map displayed on a screen of the computing device.

10. The data managing and providing method of claim 1, further comprising displaying the stored events on a calendar displayed on a screen of the computing device.
